(19) United States
(12) Patent Application Publication
(10) Pub. No.: US 2012/0265812 A1
(43) Pub. Date: Oct. 18, 2012

(54) DEVICE AND METHOD FOR PROCESSING DATA FROM USER MESSAGES TO COMMUNICATE RAPIDLY WITH CONTACTS

(76) Inventors: Fabrice Dantec, Saint Renan (FR); Michel Souben, Brest (FR); Pierre Chaptal, Brest (FR)

(21) Appl. No.: 13/384,360

(22) PCT Filed: Jun. 29, 2010
(86) PCT No.: PCT/EP2010/059186

§ 371 Date: Jun. 11, 2012

(30) Foreign Application Priority Data
Jul. 17, 2009 (EP) 09305682.8

(51) Int. Cl. G06F 15/16

(52) U.S. Cl. 709/204

(57) ABSTRACT

A device (D) is designed to process communication data from at least one user, This device (D) consists of i) the means of analysis (MA) tasked with analysing incoming and/or outgoing communications data from at least one user communication terminal (T) in order to determine selected information about said communications and the other users, called “contacts”, involved in at least one of these communications, and ii) the processing means (MT) tasked with assigning a weight to each communication involving the user according to the information determined for said communication and at least one selected rule, and then creating a contact data file in which each contact is assigned an overall weight equal to the sum of the weights assigned to each communication involving him or her and the user.

The invention concerns communication between communication terminal users, and more specifically, the devices and methods that are made available to these users to reduce the time necessary to establish communication with at least one contact.

It should be noted that the invention may involve any communication terminal type, whether wired or wireless.

Additionally, “contact” shall mean a user of at least one communication terminal (associated with a communication identifier, such as for example a telephone number, email address, or Internet address) who may have already been (and preferably was) in communication with another user, and who is potentially part of a personal and/or professional directory used by the latter. It should be noted that a contact may be known by a name, user name, number, or communication identifier.

Furthermore, the term “communication” refers to any type of connection established between a caller's (communication) terminal and at least one receiver's (communication) terminal. Consequently, it may for example be a traditional telephone call, potentially via Internet, a text message (SMS or MMS), or an instant message (or “chat” or IM), email, or video message.

As any person skilled in the art knows, several solutions have been proposed to reduce the time necessary to establish communication between a terminal user and at least one contact. Thus, a user or network administrator can associate a communication identifier with a terminal key (“shortcut”). It is also possible to create a list of contacts (“redial list”) containing the last N contacts with whom a user established incoming or outgoing communication, potentially in chronological order. It is also possible to create a list (or “call log”) of all communication identifiers from terminals that established incoming or outgoing communication with a user, potentially related to the number of communications established with each contact. It is also possible to create a restricted list of friends or relatives (or “buddy list”) containing the communication identifiers for terminals used by friends or relatives, potentially as part of a specific application (instant messaging (or IM) for example). It is also possible to create a personal and/or professional (or corporate) directory, potentially accessible via a server.

All of the solutions presented hereinabove allow users to communicate more rapidly with certain other users. However, either these solutions only offer a simple list (potentially limited) in which searching for a contact can be relatively time consuming, or they require a customised adaptation by each user according to his or her search criteria.

As no known solution is fully satisfactory, the goal of the invention is therefore to improve the situation.

For this purpose, the invention proposes a device designed to process communication data for at least one user, and consisting of:
Means of analysis tasked with analysing incoming and/or outgoing communication data from at least one user communication terminal so as to determine selected information related to these communications and to other users, called “contacts”, involved in at least one of these communications, and
Processing means tasked with assigning a weight to each communication involving the user according to the information determined for this communication and at least one selected rule, and then creating a contact data file in which each contact is assigned an overall weight that is equal to the sum of the weights assigned to each communication involving him or her, and involving the user at the same time.

The device of the invention may comprise other characteristics, which may be taken separately or in combination, in particular:
Its processing means may be tasked with assigning weights according to at least one rule selected from a group consisting of at least the communication date, the communication reply status, the communication direction (“incoming” or “outgoing”), whether or not the contact belongs to a user directory, and the number of communications between a contact and the user;
Its means of analysis may be tasked with analysing data related to incoming and/or outgoing communications within a given period, such that the processing means can update the contact data file for a user for the selected period;
Its processing means may be tasked with dynamically updating a contact data file according to incoming and/or outgoing communications;
Its processing means may be tasked with creating contact data files configured as contact lists ordered by their overall weights;
In a variation, its processing means may be tasked with creating contact data files configured as contact clouds, in which one user's contacts are positioned in an area shaped according to their global weights and in alphabetic order and/or by the age of their last communication with the user and/or by the reply status of their last communication with the user and/or by the direction of their last communication with the user. This method of presentation to the user may for example be a translation of a Web 2.0 application called a keyword cloud into the telco domain.

The invention a so proposes network equipment intended to be connected to a communication network to which user communication terminals may be connected and equipped with a processing device of the type described hereinabove.

The invention also proposes a user communication terminal designed to be connected to a communication network, and equipped with a processing device of the type described hereinabove.

The invention also proposes a method for processing communication data from at least one user consisting of the following steps:
i) Analyse incoming and/or outgoing communication data from at least one user communication terminal so as to determine selected information related to these communications and to other users, called “contacts”, involved in at least one of these communications.
ii) Assign a weight to each communication involving the user according to the information determined for this communication and at least one selected rule, and
iii) Create a contact data file in which each contact is assigned an overall weight that is equal to the sum of the weights assigned to each communication involving him or her and said user.

The method of the invention may comprise other characteristics, which may be taken separately or in combination, in particular:
At step (ii) it is possible to assign weights according to at least one rule selected from among (at least) the communication date, the communication reply status, the communication direction, whether or not the contact belongs to a user directory, and the number of communications between a contact and the user;
At step (i) it is possible to analyse data related to incoming and/or outgoing communications within a given period, in order to update the contact data file for a user for the selected period;
At step (iii) it is possible to dynamically update a contact data file according to incoming and/or outgoing communications;
At step (iii) it is possible to create contact data files configured as contact lists ordered by their overall weights;
At step (iii) it is possible to contact data files configured as contact clouds, in which one user's contacts are positioned in an area shaped according to their global weights and in alphabetic order and/or by the age of their last communication with the user and/or by the reply status of their last communication with the user and/or by the direction of their last communication with the user,

Other characteristics and advantages of the invention will become apparent upon examining the detailed description below and the attached drawings, wherein:

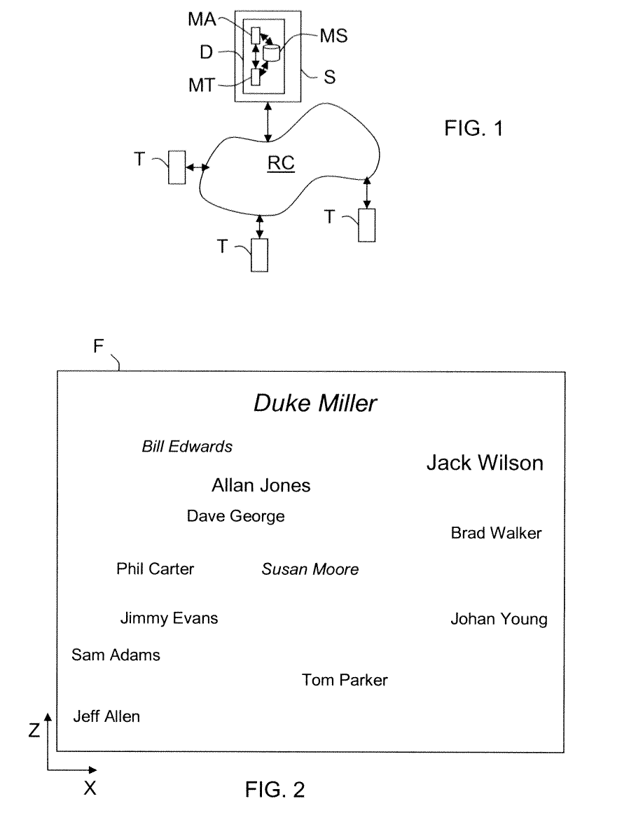

FIG. 1 highly schematically and functionally depicts network equipment with an embodiment of a processing device according to the invention and connected to a communication network, and

FIG. 2 is an example of a contact cloud display window created by the invention.

The drawings may serve not only to complete the invention, but also to contribute to defining it, if need be.

The purpose of the invention is to propose a method and a related device (D) designed to process communication data from at least one user and at least one communication terminal (T).

In what follows, it is assumed by way of a non-limiting example that the users have wireless (or cellular) communication terminals (T) able to connect to a wireless communication network (RC) (mobile or cellular). However, the invention is not limited to this type of communication terminal. In fact, it refers to any type of communication terminal capable of connecting to a wired or wireless communication network. Consequently, the communication terminals (T) may be, for example, desktop or laptop computers, wire-line or mobile telephones, potentially video, or personal digital assistants (or “PDAs”).

FIG. 1 schematically shows a (communication) network example RC to which it is possible to connect (communication) terminals T belonging to users who are (directly or indirectly (mobile)) customers of the operator of said network RC, and which is connected to the network of networks (or Internet), not shown.

The invention proposes implementing method for processing user communication data. For example, this method may be implemented with a processing device D according to the invention.

It should be noted that in the non-limiting example shown, the processing device D is part of the network equipment, such as a services server S (here connected to the network RC, but which may be coupled to the internet or may be a part of the latter). Therefore, it operates centrally for many users. However, a processing device D. according to the invention, may be part of a user's (communication) terminal T, and in this case, it operates in a distributed manner for said terminal T.

Consequently, a processing device O. according to the invention, may be constructed in the form of software (or computer) modules, or electronic circuits, or a combination of electronic circuits and software modules.

The inventive method comprises three main steps.

A first main step (i) consists of analysing (at least some) incoming and/or outgoing communication data from at least one user communication terminal T (here selected from many terminals or designated by a request) so as to determine selected information for these communications and other users, called “contacts”, involved in at least one of these communications, It should be noted that “contact” shall mean a user of at least one communication terminal that is associated with a communication identifier, to such as for example a telephone number or an email address, or an Internet address, who may have already been (and preferably was) in communication with another user, and who is potentially part of a personal and/or professional directory used by the latter. A contact may be known by a name, user name, number, or communication identifier.

It should also be noted that “communication” refers to a link established between a caller's (communication) terminal and at least one receiver's (communication) terminal, even if the receiver did not answer. Consequently, it may for example be a traditional telephone call, potentially via Internet, a text message (SMS or MMS), or an instant message (or “chat” or IM), an email, or a video message.

This first main step (i) may, for example, be implemented by the means of analysis MA on the device D.

It should be noted that not all of a given user's communications need be analysed. In fact, only certain selected ones may be analysed. Therefore, it is possible for example to decide to analyse only communications of a single type, such as for example only telephone calls, or only emails, or only instant messages (chats), potentially independently of the time when these communications took place. It is also possible to decide to analyse only communications established during at least one selected time slot, potentially independently of the respective communication types.

In the case of centralised operation, the analysis takes place among the communication data for the user in question that are stored on a call server. The latter may potentially be located in the same place as the services server S. It may also be part of the services server S. Therefore the means of analysis MA on the device D are configured to access the call server and the communication data for the users that it stores.

In the case of distributed operation, the analysis takes place either locally among the communication data for the user that are stored on the terminal T that he or she is

using, or among the communication data for the user that are stored on his or her various terminals.

The communication information for a user may be communication identifiers for contact terminals and/or contact names or user names and/or communication dates (and times) and/or communication types, for example.

It should be noted that the communication information for a user, determined by the means of analysis MA, may potentially be stored together with a user ID (potentially his or her (or one of his or her) communication identifiers) on the memory means MS on the device D, so that they can be reused locally at any time. These memory means MS may be present in any form known to a person skilled in the art, and in particular in the form of memory or a database.

It should be noted that the means of analysis MA may potentially be configured to automatically analyse the incoming and/or outgoing communication data for a given user within a selected period. In the opposite case, the analyses are carried out by request from a user terminal T or a network administrator. For example, it is possible to select a 24 hour (one day) or 12 hour (hail day) period.

A second main step (ii) of the method according to the invention consists in assigning a weight to each communication involving the user according to the information determined for this communication in the first step (i) and at least one selected rule. For example, this second main step (ii) may be implemented by the processing means MT on the device D that are coupled to the means of analysis MA and/or to potential memory means MS.

As indicated hereinabove, the weights are assigned by the processing means MT according to at least one rule selected by the given user or by a network administrator, potentially according to the user's profile.

For example, these rules can be selected from at least:
The communication date. For example one may decide that the more recent the communication, the greater its importance,
The communication reply status (that is to say, whether or not a reply has been made to an incoming or outgoing communication). For example one may decide that a communication to which no reply has been made is more important than a communication to which a reply has been made,
The communication direction (that is to say, whether or not the communication is incoming or outgoing). For example, one may decide that an outgoing and/or incoming communication to which the user in question has not replied is/are more important than an incoming communication to which the user in question has replied,
Whether or not the contact belongs to a user directory (personal and/or professional).

For example, one may decide that a contact belonging to a user directory is more important than a contact not belonging to a directory for this user,
The number of communications between a contact and the user in question. For example, one may decide that a contact with which a user communicates frequently is more important than a contact with which he or she communicates rarely, or never.

It should be noted that when a contact is part of a user directory stored on that user's terminal T or in a database (that stores directories for users of the service provided by the invention), this terminal T or the database must be called.

Additionally, it should be noted that when a first user has not communicated with a second user, the latter may however be a contact of the first user. In this case, it is possible for example to assign the second user (here a contact) a weight of zero (0).

It should be understood that the more important a communication is considered to be, the greater the weight assigned to it.

By way of a purely illustrative example, at least some of the following complex rules may be applied:
A weight of 32 is assigned to each outgoing communication within the past hour that received no reply,
A weight of 16 is assigned to each incoming communication within the past hour that received no reply,
A weight of 16 is assigned to each outgoing communication within the past hour that received a reply,
A weight of 8 is assigned to each incoming communication within the past hour that received a reply,
A weight of 8 is assigned to each outgoing communication made within the five hours prior to the past hour,
A weight of 4 is assigned to each incoming communication made within the five hours prior to the past hour,
A weight of 4 is assigned to each outgoing communication made within the 18 hours prior to the past six hours,
A weight of 2 is assigned to each incoming communication made within the 18 hours prior to the past six hours,
A weight of 2 is assigned to each outgoing communication made within the six days prior to the past day,
A weight of 1 is assigned to any other communication concerning a contact associated with a shortcut key on a user terminal T or to the user's list of friends (or relatives) or to the user's personal directory,
A weight of 0 is assigned to any other communication concerning a contact that is not associated with a shortcut key on a user terminal T. the user's list of friends (or relatives), or to the user's personal directory.

It should be noted that the rules used may potentially vary from one user to another, for example according to their user profiles and/or to a context taken into consideration and/or to a choice the user makes (potentially according to his or her needs and/or habits).

A third main step (iii) of the method according to the invention consists of creating a contact data file in which each contact is assigned an overall weight that is equal to the sum of the weights assigned to each communication involving him or her and the user in question.

In other words, one takes a contact for a given user, and then one determines each communication involving both this user and this contact, and to which a weight has been assigned, then one sums the weights that have been respectively assigned to the communications thus determined to obtain the overall weight associated with this contact.

For example, this third main step (iii) may be implemented by the processing means MT of the device D.

The contact data files that are created may be shown in at least two formats. Thus, for example, they may be shown in the form of contact lists in which the contacts are ordered by the overall weights assigned to them.

In a variation, the contact data files may for example be shown in the form of clouds of contacts. More specifically, a cloud of contacts for a given user consists of a selected graphical representation of this user's contacts. Therefore these contacts are positioned in an area shaped according to their global weights and in alphabetic order and/or by the age of their last communication with the user and/or by the reply status of their last communication with the user and/or by the direction of their last communication with the user in question.

This method of presentation to a user may for example be a translation of a Web 2.0 application called a keyword cloud into the telco domain.

For example, contacts may be positioned within a rectangular or (square) area. But, the area may be shown in other shapes, geometrical or not.

FIG. 2 shows a non-limiting example of a display window F of a contact cloud created by the invention. In this example, the contacts are identified by their names (or user names). However, this is not mandatory. In fact, they may be identified by numbers or communication identifiers, for example, even though this does not facilitate their immediate recognition. Additionally, in this example:
The horizontal axis X of window F shows contact names in alphabetical order, with the letter A being farthest to the left and the letter Z being the farthest to the right,
The vertical axis Z of window F shows the age of the last communication made with a contact, the oldest communication closest to the bottom and the most recent communication being closest to the top,
The size of the contact names shows the overall weight assigned to a contact (the greater the size, the higher the weight),
Contact names in italics (or for example in red and/or underlined) show that the last communication made with a contact was an incoming communication to which no reply has been made, on as to facilitate detection of contacts to which it would be preferable to call back,
Contact names in italics (or for example in red and/or underlined) and blinking show that the last communication made with a contact was an incoming communication associated with a call back request,
Contact names in normal characters (non-italic) and for example in blue show that the last communication made with a contact was an outgoing communication to which no reply has been made, so as to facilitate detection of contacts to which it would be preferable to call back,
Contact names in normal characters (non-italic) and for example in black show that the last communication made with a contact was an outgoing or incoming communication to which a reply was made.

Of course, some of the aforementioned display criteria for a contact cloud may not be used and/or other display criteria may be used. Thus, for example, it is possible to envision not taking into account the age of the most recent communication with a contact. In general, it is possible to envision that the user may select the presentation format most suitable for him or her.

It should be noted that it is possible to envision that the name of a contact displayed in a window F within an ordered list or a cloud, should allow access to all or some of the information known about this contact when selected. For example, this information is stored in a user database not shown but accessible on device D. Therefore, selecting a name from a window F displayed on the screen of terminal T could for example display a sub-window with the name of the contact, his or her fixed-line telephone number, his or her mobile telephone number, and his or her email address or addresses, as well as one or more icons representing the type of terminal T on which one wishes to reach the selected contact and/or the type of communication that one wishes to make with the selected contact. Selecting an icon would then automatically establish the corresponding communication.

It should also be noted that the processing means MT may be tasked with dynamically updating the (pre-existing) contact data file for a given user according to that user's incoming and/or outgoing communications.

It should also be noted that in the centralised case, the user must send a request to the server S with one of his or her terminals T, so as to be able to download the contact data file that was created specifically for him or her onto this terminal T.

The invention is not limited to the embodiments of the processing device, communication terminal, and processing method described hereinabove, which are only given by way of example; rather, it encompasses all variants that a person skilled in the art may envision within the framework of the claims below.

1. Processing device for communication data from at least one user, wherein by having i) means of analysis (MA) configured to analyse incoming and/or outgoing communication data from at least one user communication terminal (T) to determine selected information about said communications and the other users, called “contacts”, in relation to at least one of said communications, and ii) processing means (MT) configured to assign a weight to each communication involving said user according to said information determined for this communication and at least one selected rule, then to create a contact data file in which each contact is assigned an overall weight equal to the sum of the weights assigned to each communication involving him or her and said user.

2. Device according to claim 1, wherein said processing means (MT) are configured to assign said weights according to at least one rule selected from a group containing at least the communication date, the communication reply status, the communication direction, whether or not the contact belongs to a user directory, and the number. of communications between a contact and said user.

3. Device according to claim 1, wherein said means of analysis (MA) are configured to analyse said incoming and/or outgoing communication data for a selected period, such that said processing means (MT) can update the contact data file for a user for the selected period.

4. Device according to claim 1, wherein said processing means (MT) are configured to dynamically update a contact data file for a user according to incoming and/or outgoing communications on said user's terminal (T).

5. Device according to claim 1, wherein said processing means (MT) are configured to create contact data files configured as contact lists ordered by their assigned overall weights.

6. Device according to claim 1, wherein said processing means (MT) are configured to create contact data files configured in the form of contact clouds in which said contacts for a user are positioned in an area of a selected shape according to their overall assigned weight and in alphabetical order and/or by the age of their last communication with said user and/or the reply status of their last communication with said user and/or the direction of their last communication with said user.

7. Network equipment (S) suitable for connection to a communication network (RC) to which user communication terminals (T) may be connected, wherein it contains a processing device (D) according to claim 1.

8. User communication terminal (T) suitable for connecting to a communication network (RC), wherein it contains a processing device (D) according to claim 1.

9. Processing method for communication data from at least one user, wherein by consisting of the following steps: i) analyse incoming and/or outgoing communication data from at least one user communication terminal (T) to determine selected information about said communications and the other users, called “contacts”, in relation to at least one of said communications, ii) assign a weight to each communication involving said user according to said information determined for this communication and at least one selected rule, and iii) create a contact data file in which each contact is assigned an overall weight equal to the sum of the weights assigned to each communication involving him or her and said user.

10. Method according to claim 9, wherein step (ii) assigns said according to at least one rule selected from a group containing at least the communication date, the communication reply status, the communication direction, whether or not the contact belongs to a user directory, and the number of communications between a contact and said user.

11. Method according to claim 9, wherein step (i) analyses said incoming and/or outgoing communication data for a selected period, so as to update the contact data file for a user for the selected period.

12. Method according to claim 9, wherein step (iii) dynamically updates a contact data file for a user according to incoming and/or outgoing communications from said user's terminal (T).

13. Method according to claim 9, wherein step (iii) creates contact data files configured in the form of lists ordered by their overall assigned weights.

14. Method according to claim 9, wherein step (iii) creates contact data files configured in the form of contact clouds in which said contacts for a user are positioned in an area of a selected shape according to their overall assigned weight and in alphabetical order and/or by the age of their last communication with said user and/or the reply status of their last communication with said user and/or the direction of their. last communication with said user.
